(19) United States
(12) Patent Application Publication
(10) Pub. No.: US 2006/0167666 A1
(43) Pub. Date: Jul. 27, 2006

(54) Method for extracting the equivalent model of couple transmission line in high-speed circuit

(75) Inventor: Shou-Kuo Hsu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/323,245

(22) Filed: Dec. 30, 2005

(30) Foreign Application Priority Data
Jan. 22, 2005 (CN) 200510032979.1

(51) Int. Cl. G06F 17/10

(52) U.S. Cl. 703/2

(57) ABSTRACT

A method of extracting an equivalent model of couple transmission line in high-speed circuit includes the steps of: using signals in an even mode and odd mode to excite the couple transmission line respectively; obtaining voltages by measuring the couple transmission line in the excitation of the signals in the even mode and the odd mode respectively; based on the measured voltages, obtaining impedance profiles of a lumped circuit respectively in the even mode and the odd mode by layer peeling transmission line synthesis; obtaining circuit parameters of the lumped circuit by the genetic algorithm; and extracting an equivalent model of the couple transmission line according to the relationship of the excitation of the even mode and odd mode.

### BACKGROUND OF THE INVENTION

1. Field of the Invention

The present invention relates to a method of extracting an equivalent model of a couple transmission line in a high-speed circuit.

2. General Background

Recently, interconnection lines on integrated circuits (IC), multichip modules (MCM), and printed circuit boards (PCB) have become critical elements for determining the performance of current high-speed integrated circuits and systems. As low-swing components, clock rates and bus speeds have increased dramatically, packaging and interconnections have greater importance, and in some cases they actually limit the system performance. Due to high-speed signal propagating on these interconnections, electrical design issues such as signal integrity, delay, via-holes and cross-talk become critical. In order to accurately simulate the effect of interconnection in high-speed system, EDA simulation software requires more accurate equivalent circuit model of component to eliminate the debugging procedure and reduce the EMI/SI problem, as well as to shorten the circuit design cycle.

It is therefore apparent that a need exits to provide a method for extracting the equivalent model of couple transmission line in high-speed circuit.

### SUMMARY

In one preferred embodiment, a method for extracting an equivalent model of a couple transmission line in a high-speed circuit includes the steps of: using signals in an even mode and odd mode to excite the couple transmission line respectively; obtaining voltages by measuring the couple transmission line in the excitation of the signals in the even mode and the odd mode respectively; based on the measured voltages, obtaining impedance profiles of a lumped circuit respectively in the even mode and the odd mode by layer peeling transmission line synthesis; obtaining circuit parameters of the lumped circuit by the genetic algorithm; and extracting an equivalent model of the couple transmission line according to the relationship of the excitation of the even mode and odd mode.

The method is provided to reconstruct the physically structures of a nonuniform couple transmission lines from layer peeling algorithm and genetic algorithm. Base on the time domain reflection (TDR) measurement, the impedance profile of the device under test (D.U.T) is first derived by layer peeling transmission line synthesis. Then, the genetic algorithm (G.A.) is employed to extract the parameter of the lumped/distributed circuits in high-speed digital circuit. As a result, the system characteristic can be easily obtained by the extracted model and a SPICE circuit simulation software.

Other advantages and novel features will become more apparent from the following detailed description when taken in conjunction with the accompanying drawings, in which:

### BRIEF DESCRIPTION OF THE DRAWINGS

FIG. 1 is a flow chart of a method of extracting an equivalent model of a couple transmission line in a high-speed circuit in accordance with a preferred embodiment of the preset invention;

FIG. 2 is a lattice diagram of a transmission line in accordance with the preferred embodiment of the preset invention;

FIG. 3 is a lossless couple transmission lines circuit;

FIGS. 4A and 4B are diagrams using an even mode signal and odd mode signal to excite the couple transmission line of FIG. 2 respectively;

FIGS. 5A and 5B are distributed circuits in an equivalent circuit model and a lumped equivalent circuit model;

FIGS. 6A and 6B, are impedance profiles of the even mode and odd mode excitation equivalent circuit model of FIG. 5;

FIG. 7A is a diagram showing the measurement data of TDR and the reconstructed results by GA in the even mode; and

FIG. 7B is a diagram showing the measurement data of TDR and the reconstructed results by GA in the odd mode.

### DETAILED DESCRIPTION OF THE EMBODIMENTS

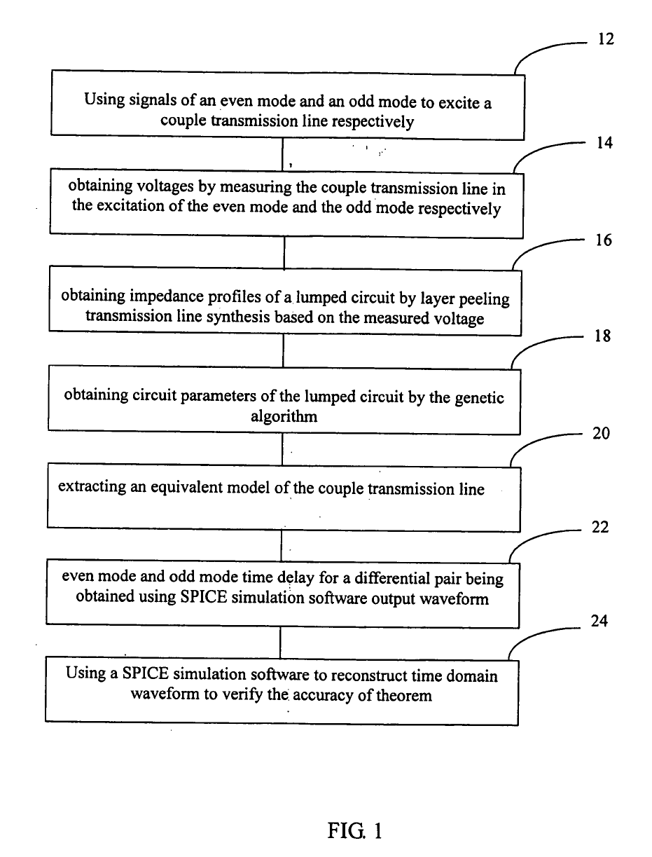

Referring to FIG. 1, a flow chart of a method of extracting an equivalent model of a couple transmission line in high-speed circuit includes the following steps.

Step 12: using signals in an even mode and an odd mode to excite a couple transmission line respectively.

Step 14: obtaining voltages by measuring the couple transmission line in the excitation of the signals in the even mode and the odd mode respectively.

Step 16: obtaining impedance profiles of a lumped circuit respectively in the even mode and the odd mode by layer peeling transmission line synthesis based on the measured voltages.

Step 18: obtaining circuit parameters of the lumped circuit by the genetic algorithm.

Step 20: extracting an equivalent model of the couple transmission line according to the relationship of the excitation of the even mode and odd mode.

Step 22: even mode and odd mode time delay for a differential pair being obtained using a SPICE simulation software output waveform.

Step 24: using the SPICE simulation software to reconstruct time domain waveform to verify the accuracy of theorem of the genetic algorithm.

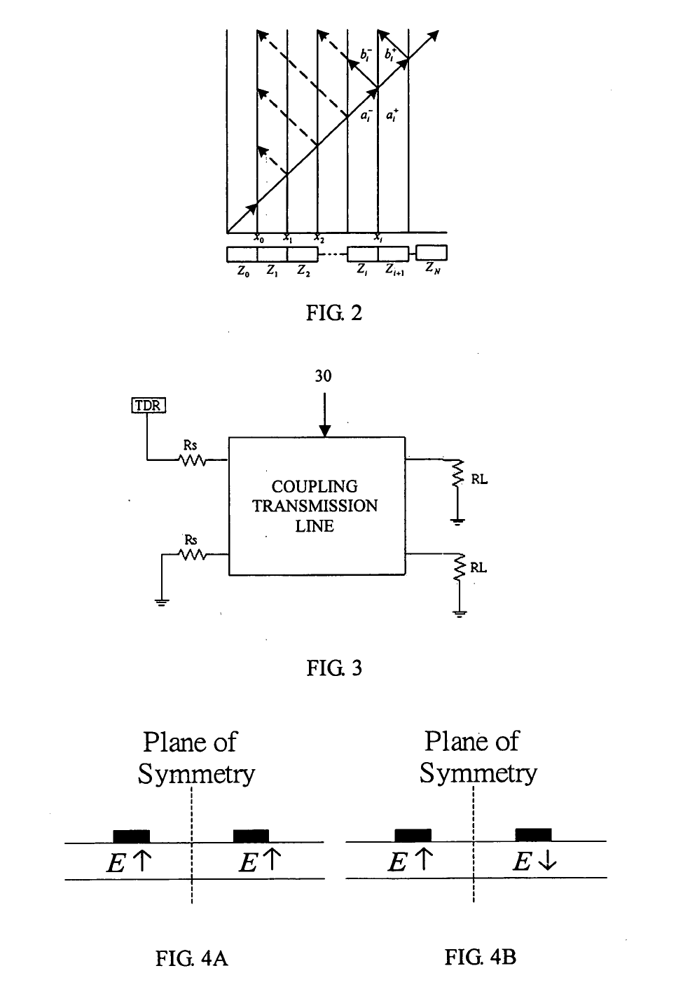

Referring to FIG. 2, a lattice diagram of a cascaded transmission line is shown, a series of N+1 uniform impedance section Z₀, Z₁, . . . Zᵢ, Z_{N} of equal electrical length represent the nonuniform transmission line. The length of each section Z₀, Z₀, . . . Zᵢ, Z_{N} is equal, Numerals X₀, X₁, . . . Xᵢ represent dividing interfaces of the two adjacent section. Each section Z₀, Z₁, . . . Zᵢ, Z_{N} is characterized by its impedance Z(x), current I(x,t), and voltage V(x,t), then incident waves a and reflected waves b can be expressed as follows:

$$\begin{matrix}a ( x , t ) = \frac{1}{2} [ \frac{V ( x , t )}{\sqrt{Z ( x )}} + I ( x , t ) \sqrt{Z ( x )} ] & ( 1 ) \\ b ( x , t ) = \frac{1}{2} [ \frac{V ( x , t )}{\sqrt{Z ( x )}} - I ( x , t ) \sqrt{Z ( x )} ] & ( 2 )\end{matrix}$$

By the continuity of voltage and current at x=xi, equations (1) and (2) are represented as following:
\sqrt{Z_{i−1}}(aᵢ⁻+bᵢ⁻)=\sqrt{Zᵢ}(aᵢ⁺+bᵢ⁺) (3)
\sqrt{Zᵢ}(aᵢ⁻−bᵢ⁻)=\sqrt{Z_{i−1}}(aᵢ⁺−bᵢ⁺) (4
wherein aᵢ⁻ and aᵢ⁺ are the incident waves at the interface of the ith section Zi and (i+1)th section Zᵢ₊₁ respectively, and reflected waves bᵢ⁻ and bᵢ⁺ are the reflect waves at the interface of the ith section Zi and (i+1)th section Zᵢ₊₁ respectively. The wave variables aᵢ⁺ and bᵢ⁺ is solved as follows:

$$[ \begin{matrix}{a}_{i}^{+} \\ {b}_{i}^{+}\end{matrix} ] = \frac{1}{\sqrt{1 - {S}_{i}^{2}}} [ \begin{matrix}1 & - {S}_{i} \\ - {S}_{i} & 1\end{matrix} ] [ \begin{matrix}{a}_{i}^{-} \\ {b}_{i}^{-}\end{matrix} ] \qquad ( 5 )$$

wherein Sᵢ is the reflection coefficient. The incident waves and reflected waves at xᵢ are defined as piecewise constant functions; equation (1) and (2) in the first section at x₁ as follows:

$$\begin{matrix}{a}_{1 , j}^{-} = \frac{1}{2} [ \frac{V ( 2 ( j - 1 ) Δ t )}{\sqrt{{Z}_{0}}} + I ( 2 ( j - 1 ) Δ t ) \sqrt{{Z}_{0}} ] & ( 6 ) \\ {b}_{1 , j}^{-} = \frac{1}{2} [ \frac{V ( 2 ( j - 1 ) Δ t )}{\sqrt{{Z}_{0}}} - I ( 2 ( j - 1 ) Δ t ) \sqrt{{Z}_{0}} ] & ( 7 )\end{matrix}$$

wherein j=1,2,3, . . . N, Z₀ is the source impedance and Δt=Δx/c, c is the wave propagation velocity; the time interval (2Δt) is because a change in the reflected wave caused by the junction i+1 occurs no sooner than 2Δt after that due to junction i Equation (5) is represented as following:

$$[ \begin{matrix}{a}_{i , j}^{+} \\ {b}_{i , j}^{+}\end{matrix} ] = \frac{1}{\sqrt{1 - {S}_{i}^{2}}} [ \begin{matrix}1 & - {S}_{i} \\ - {S}_{i} & 1\end{matrix} ] [ \begin{matrix}{a}_{i , j}^{-} \\ {b}_{i , j}^{-}\end{matrix} ] \qquad ( 8 )$$

The relation of incident and reflected at the interface of xᵢ and xᵢ₊₁ section is as following:
a_{i+1,j}⁻a_{i,j}⁺
b_{i+1,j}⁻=a_{i,j+1}⁺ for j=1,2,3 . . . N−i (9)

Referring to FIG. 3, a lossless couple transmission lines circuit is shown, the figure is a circuit mode defined according to the physical characteristic of the transmission line. Wherein Rs is an equivalent impedance of a Time Domain Reflection system, RL is an impedance of a loading circuit, the values of the Rs and RL are 50 ohms. The characteristic impedance of a transmission line can be described using its inductance, capacitance, and conductance per unit length as follows:

$$z = \sqrt{\frac{L}{C}} \qquad ( 13 )$$

The electrical length t of such a line can be determined by using the following equation:
t=l\sqrt{LC} (14)
Wherein l is the physical length of the line.

Referring to FIG. 4A and FIG. 4B, are diagrams using an even mode and odd mode signal to excite a couple transmission line respectively. In FIG. 4A and FIG. 4B, arrows show the direction of an input signal. Voltages in the same phase are applied to the transmission line of even mode, voltages in the opposite phase are applied to the transmission line of the odd mode. The LC matrices can be easily extracted from the even and odd TDR impedance profiles using following equations:

$$\begin{matrix}{L}_{s} = \frac{1}{2 Δ l} ( {Z}_{even} {T}_{even} + {Z}_{odd} {T}_{odd} ) & ( 15 ) \\ {L}_{m} = \frac{1}{2 Δ l} ( {Z}_{even} {T}_{even} - {Z}_{odd} {T}_{odd} ) & ( 16 ) \\ {C}_{s} = \frac{1}{2 Δ l} ( \frac{{T}_{ odd}}{{Z}_{ odd}} + \frac{{T}_{ even}}{{Z}_{ even}} ) & ( 17 ) \\ {C}_{m} = \frac{1}{2 Δ l} ( \frac{{T}_{ odd}}{{Z}_{ odd}} - \frac{{T}_{ even}}{{Z}_{ even}} ) & ( 18 )\end{matrix}$$

Wherein Lₛ, Lₘ, Cₛ, and Cₘ are self-inductance, mutual-inductance, self-capacitance and mutual-capacitance, respectively. Zₑᵥₑₙ, Z_{odd}, Tₑᵥₑₙ, and T_{odd} are even-mode impedance, odd-mode impedance, even-mode time delay, and odd-mode time delay, respectively.

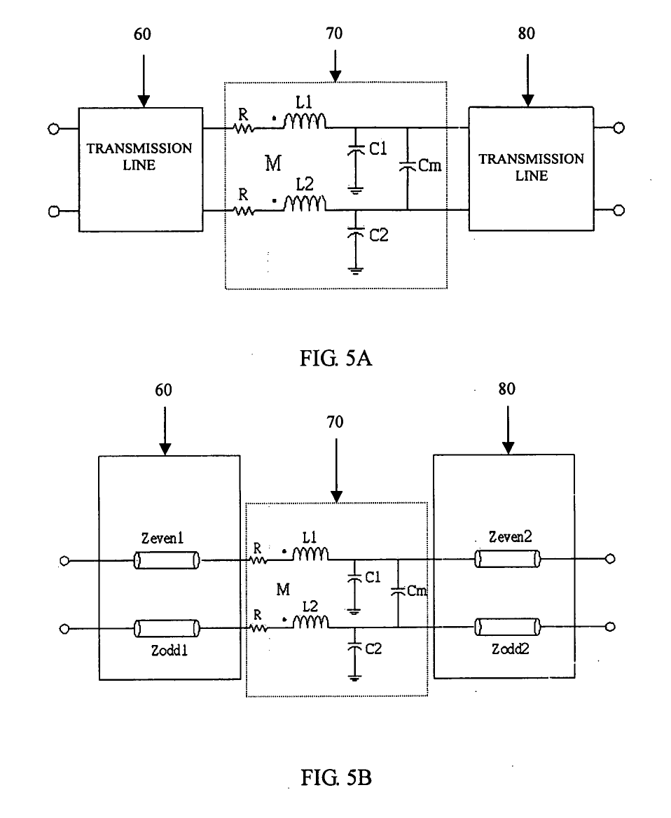

Referring to FIGS. 5A and 5B, are distributed circuits in equivalent circuit model and a lumped equivalent circuit model. A first transmission line 60 is discontinue with a second transmission line 80, a discontinue point 70 is defined between the first transmission line 60 and the second transmission line 80. The impedance profile of distributed circuit in equivalent circuit model is determined by layer peeling transmission line synthesis and the parameters of the lumped circuit in equivalent circuit model is determined by the genetic algorithm. L1 and L2 denote self inductance, Lm denotes mutual inductance, C1 and C2 denote self capacitance, and Cm denotes mutual capacitance. FIG. 5B is a mode decomposition lumped equivalent circuit of FIG. 5A. Zₑᵥₑₙ₁ and Z_{odd1} denote the impedance of the first transmission line 60. Zₑᵥₑₙ₂ and Z_{odd2} denote the impedance of the second transmission line 80. In the ordinary course of things, the impedance of the first transmission line 60 is same with the second transmission line 80, that is, Zₑᵥₑₙ₁=Zₑᵥₑₙ₂, Z_{odd1}=Z_{odd2}, L1=L2, C1=C2.

The method of present invention is to reconstruct the physically structures of a nonuniform couple transmission lines from layer peeling algorithm and genetic algorithm. TDR measurement system is used to get the transient response (V_{tdr}) of the unknown circuits. Once V_{tdr} is obtained, the characteristic impedance profile of the D.U.T is firstly derived by layer peeling transmission line synthesis, then the genetic algorithm is used to find the parameters of the lumped circuit in the D.U.T. Genetic algorithms are the global numerical optimization methods based on genetic recombination and evolution in nature. Using the iterative optimization procedures that start with a randomly selected population of potential solutions, and then gradually evolving toward a better solution through the application of the genetic operators: reproduction, crossover and mutation operators. In the present invention, genetic algorithm is used to find the parameters of the lumped circuit in the D.U.T by minimizing the following cost function:

$$CS = {\{ \frac{1}{K} {\sum }_{i = 1}^{K} {\vert {V}_{tdr}^{exp} ( t ) - {V}_{tdr}^{cal} ( t ) \vert}^{2} \}}^{1 / 2} \qquad ( 10 )$$

wherein K is the total number of time steps of V_{tdr} measured by TDR. V_{tdr}^{exp}(t) and V_{tdr}^{cal}(t) are the measured voltage and calculated voltage, respectively. To calibrate the multi-reflection effect in the TDR measurement data, the V_{tdr}^{cal}(t) is recombined by a_{i,j} and b_{i,j} at discontinuity interface xᵢ:

$${V}_{tdr}^{cal} ( j ) = ( \frac{{a}_{1 , j}^{-}}{{a}_{i , j}^{-}} ) ( {a}_{i , j}^{-} + {b}_{i , j}^{-} ) \sqrt{{z}_{0}} \qquad ( 11 )$$

wherein parameters L, Lₘ, C, Cₘ and R are coded by the following equations:

$$x = {p}_{min} + \frac{( {p}_{max} - {p}_{min} )}{{2}^{′} - 1} \times {\sum }_{i = 0}^{l - 1} {b}_{i} {2}^{i} \qquad ( 12 )$$

Wherein x represents the value of the parameters L, Lₘ, C, Cₘ and R; bᵢ is the l-bit string of the binary representation of x; pₘᵢₙ and Pₘₐₓ are the minimum and maximum value admissible for x, respectively. Pₘᵢₙ and Pₘₐₓ can be determined by experience and actual physics quantity in the high-speed digital circuit. Also, the finite resolution with which L, Lₘ, C, Cₘ, and R can be tuned in practice is reflected in the number of bits assigned to it. The total unknown coefficients in equation (11) would then be described by a (n×l) bit string, wherein n is total number of unknown parameters in the equivalent circuit of lumped circuit in the D.U.T.

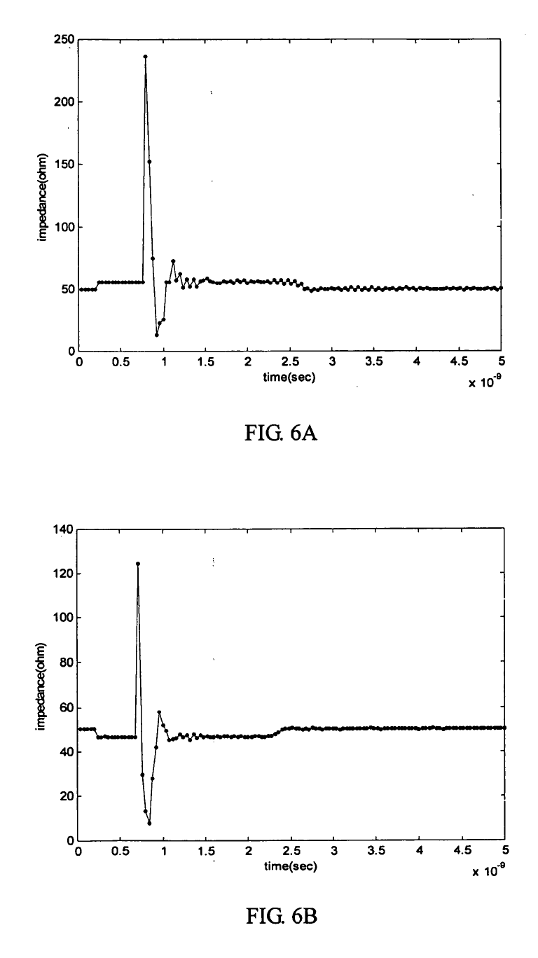

Referring to FIGS. 6A and 6B, are impedance profile of the even mode and odd mode excitation equivalent circuit model.

It is seen that there is a discontinuous at 0.77 ns by even-mode excitation and one at 0.69 ns by odd-mode excitation. The time delay is twice of the specified value because of the round trip time. The characteristic impedance of Zₑᵥₑₙ₁ and Zₑᵥₑₙ₂ are all 56 Ω shown in FIG. 5A, the characteristic impedance of Z_{odd1} and Z_{odd2} are all 46.5 Ω shown in FIG. 5B.

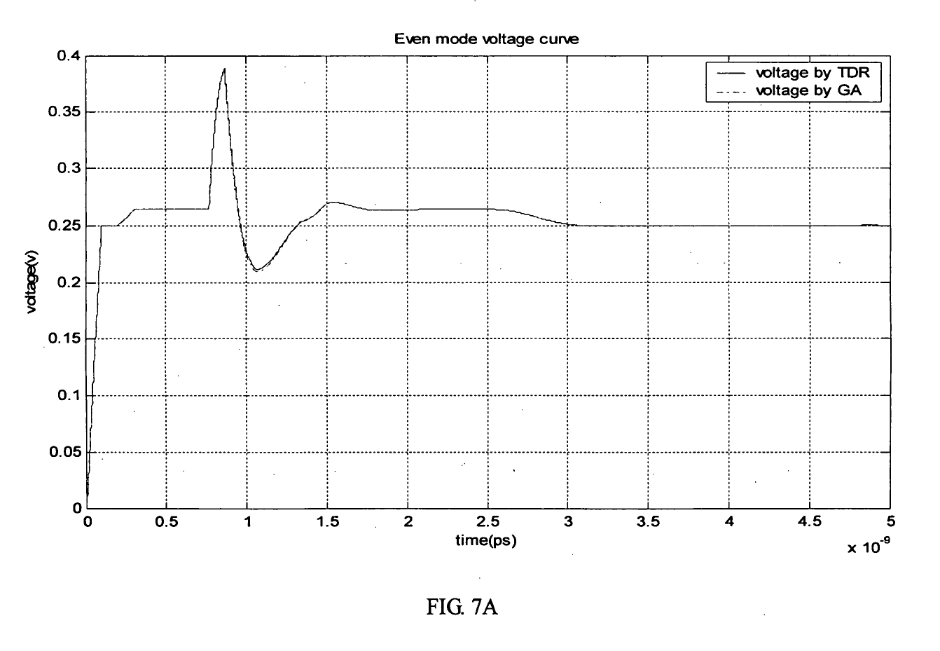

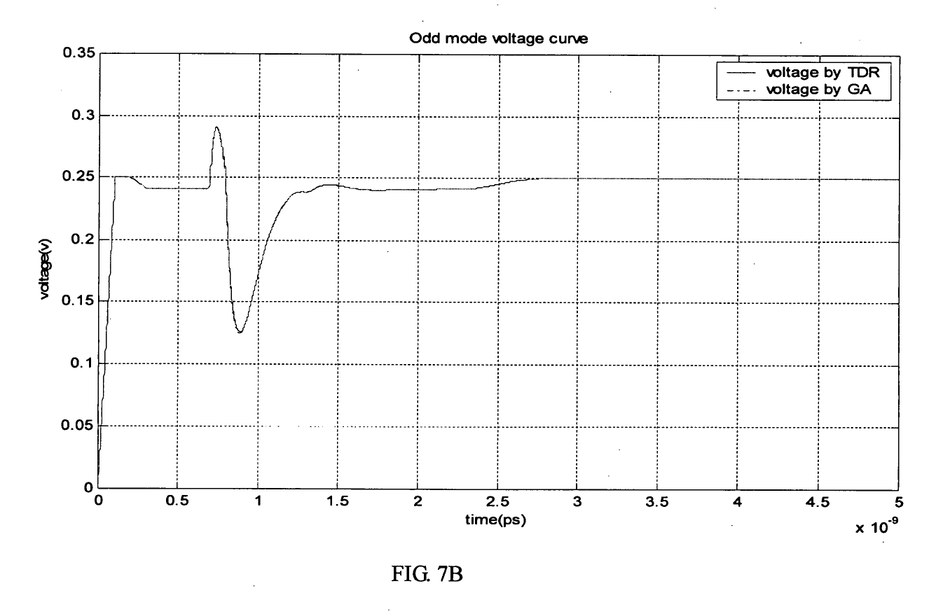

To get the parameter of the lumped circuit of this interconnection discontinuity by genetic algorithm, the population size is selected as 100 (i.e., M=100); the binary string length of those parameter are set to be 16 bit (i.e., l=16). Note that there are five unknown parameters (n=5) in FIG. 4. As a result, the bit number of a chromosome is 32 bits in FIG. 4A and FIG. 4B. A search range for the unknown resistance R is chosen to be from 0 to 0.1 Ω, the search range for the unknown self and mutual inductance is chosen to be from 0 to 10 nH, the search range for the unknown self and mutual capacitor is chosen to be from 0 to 10 pF. The crossover probability and mutation probability are set to be 0.7 and 0.03, respectively. For the equivalent model in FIG. 4B, the measurement data of TDR and the reconstructed result are plotted in FIG. 6. The final solution of parameters are: L1=L2=5.899 nH, C1=C2=3.089 pF, Lₘ=2.89 nH, Cₘ=0.98 pF, R=4.65×10⁻² Ω, the R.M.S. error of the voltage is 3.856×10⁻². In the present embodiment, the couple transmission lines can be easily analysis by the equation (15)-(18), the self inductance L1=L2=6 nH, self capacitive C1=C2=3 pF, mutual inductance Lₘ=3 nH, mutual capacitive Cₘ=1 pF, and resistance R=0.05Ω. The parameters of the lumped circuit obtaining by the genetic algorithm are very close to the actual parameters. FIG. 7A and FIG. 7B are comparative diagrams showing the measurement data of TDR and the reconstructed results by G.A. Waveforms obtained by the measurement data of TDR, and the reconstructed results by G.A are nearly superposed upon each other, the method can extract the equivalent model of the couple transmission line in high-speed circuit accurately.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for extracting an equivalent model of a couple transmission line in a high-speed circuit comprising the steps of:
using signals in an even mode and an odd mode to excite a couple transmission line respectively;
obtaining voltages by measuring the couple transmission line in the excitation of the signals in the even mode and the odd mode respectively;
obtaining impedance profiles of a lumped circuit respectively in the even mode and the odd mode by layer peeling transmission line synthesis based on the measured voltages;
obtaining circuit parameters of the lumped circuit by the genetic algorithm; and
extracting an equivalent model of the couple transmission line according to a relationship of the excitation of the even mode and odd mode.

2. The method as claimed in claim 1, further comprising the step of: even mode and odd mode time delay for a differential pair being obtained using a SPICE simulation output waveform.

3. The method as claimed in claim 1, further comprising the step of: using a SPICE simulation software to reconstruct time domain waveform to verify the accuracy of theorem.

4. The method as claimed in claim 1, wherein the relationship of the excitation of the even mode and odd mode is as follows:
$$\begin{matrix}{L}_{ m} = \frac{1}{ 2 Δ l} ( {Z}_{ even} {T}_{ even} - {Z}_{ odd} {T}_{ odd} ) \\ {C}_{ s} = \frac{1}{ 2 Δ l} ( \frac{ {T}_{ odd}}{ {Z}_{ odd}} + \frac{ {T}_{ even}}{ {Z}_{ even}} ) \\ {C}_{ m} = \frac{1}{ 2 Δ l} ( \frac{ {T}_{ odd}}{ {Z}_{ odd}} - \frac{ {T}_{ even}}{ {Z}_{ even}} )\end{matrix}$$
Wherein Lₛ, Lₘ, Cₛ, and Cₘ are self-inductance, mutual-inductance, self-capacitance and mutual-capacitance, respectively, Zₑᵥₑₙ, Z_{odd}, Tₑᵥₑₙ, and T_{odd} are even-mode impedance, odd-mode impedance, even-mode time delay, and odd-mode time delay, respectively.
